(19) United States
(12) Patent Application Publication
(10) Pub. No.: US 2012/0242864 A1
(43) Pub. Date: Sep. 27, 2012

(54) FLASH DETECTION AND CLUTTER REJECTION PROCESSOR

(76) Inventors: Myron R. PAULI, Vienna, VA (US); Cedric T. YOEDT, Washington, DC (US); William SEISLER, Lemont, PA (US)

(21) Appl. No.: 13/236,919

(22) Filed: Sep. 20, 2011

Related U.S. Application Data
(60) Provisional application No. 61/384,452, filed on Sep. 20, 2010.

(51) Int. Cl. H04N 9/68

(52) U.S. Cl. 348/236; 348/234; 348/E09.053

(57) ABSTRACT

An apparatus including an event detection filter and a spatial event accumulator. The event detection filter receives at least one camera video output and generating a plurality of difference images from a time sequence. Each difference image is based on a time-subtraction of the current image from the previous image, the time sequence above an ambient pixel intensity level including at least one of at least one true flash event and at least one false positive. The spatial event accumulator receives the plurality of difference images from the event detection filter, merges a plurality of spatially proximate smaller flash events of the possible flash event to determine a shape of a single larger flash event, and measures pixel intensities of the plurality of spatially proximate smaller flash events to determine a varying brightness over the shape of the single larger flash event.

### CROSS-REFERENCE TO RELATED APPLICATIONS

The present application claims priority to U.S. Provisional Patent Application Ser. No. 61/384,452 filed 20 Sep. 2010, incorporated herein by reference.

### FIELD OF THE INVENTION

The present invention relates generally to a system for detecting and locating short-duration flash events in a complex dynamic clutter background and more particularly to a system for remotely detecting and locating muzzle blasts, such as produced by rifles, artillery and other weapons, and by other similar explosive events.

### BACKGROUND OF THE INVENTION

Determination of the location and identity of flash events within the area under surveillance enable time-critical decisions to be made on the allocation of resources.

U.S. Pat. No. 5,686,889 to Hillis relates to an infrared sniper detection enhancement system. According to this Hillis patent, firing of small arms results in a muzzle flash that produces a distinctive signature which is used in automated or machine-aided detection with an IR (infrared) imager. The muzzle flash is intense and abrupt in the 3 to 5 μm band. A sniper detection system operating in the 3 to 5 μm region must deal with the potential problem of false alarms from solar clutter. Hillis reduces the false alarm rate of an IR based muzzle flash or bullet tracking system (during day time) by adding a visible light (standard video) camera. The IR and visible light video are processed using temporal and/or spatial filtering to detect intense, brief signals like those from a muzzle flash. The standard video camera helps detect (and then discount) potential sources of false alarm caused by solar clutter. If a flash is detected in both the IR and the visible spectrum at the same time, then the flash is mostly probably the result of solar clutter from a moving object. According to Hillis, if a flash is detected only in the IR, then it is most probably a true weapon firing event.

U.S. Pat. No. 3,936,822 to Hirshberg relates to a round detecting method and apparatus for automatically detecting the firing of weapons, such as small arms, or the like. According to the Hirshberg patent, radiant and acoustic energy produced upon occurrence of the firing of a weapon and emanating from the muzzle thereof are detected at known, substantially fixed, distances therefrom. Directionally sensitive radiant and acoustic energy transducer means directed toward the muzzle to receive the radiation and acoustic pressure waves therefrom may be located adjacent each other for convenience. In any case, the distances from the transducers to the muzzle and the different propagation velocities of the radiant and acoustic waves are known. The detected radiant (e.g. infrared) and acoustic signals are used to generate pulses, with the infrared initiated pulse being delayed and/or extended so as to at least partially coincide with the acoustic initiated pulse; the extension or delay time being made substantially equal to the difference in transit times of the radiant and acoustic signals in traveling between the weapon muzzle and the transducers. The simultaneous occurrence of the generated pulses is detected to provide an indication of the firing of the weapon. With this arrangement extraneously occurring radiant and acoustic signals detected by the transducers will not function to produce an output from the apparatus unless the sequence is corrected and the timing thereof fortuitously matches the above-mentioned differences in signal transit times. If desired, the round detection information may be combined with target miss-distance information for further processing and/or recording.

U.S. Pat. No. 6,496,593 to Krone et al. relates to an optical muzzle blast detection and counterfire targeting system and method. The Krone et al patent discloses a system for remote detection of muzzle blasts produced by rifles, artillery and other weapons, and similar explosive events. The system includes an infrared camera, image processing circuits, targeting computation circuits, displays, user interface devices, weapon aim point measurement devices, confirmation sensors, target designation devices and counterfire weapons. The camera is coupled to the image processing circuits. The image processing circuits are coupled to the targeting location computation circuits. The aim point measurement devices are coupled to the target computation processor. The system includes visual target confirmation sensors which are coupled to the targeting computation circuits.

U.S. Patent Application Publication No. 2007/0125951 to Snider et al. relates to an apparatus and method to detect, classify and locate flash events. Some of the methods detect a flash event, trigger an imaging system in response to detecting the flash event to capture an image of an area that includes the flash event, and determines a location of the flash event.

### BRIEF SUMMARY OF THE INVENTION

An illustrative embodiment of the instant invention includes a Flash Detector and Clutter Rejection Processor for detecting and locating short-duration “flash” events in complex dynamic “clutter” backgrounds with a highly reduced rate of false positives. The processor responds to camera video by analyzing a flow of video frames from one or more cameras. Additional inputs from other sensors, some of which may be cued by the processor itself, can be used for enhanced operation. The user optionally supplies inputs into the processor to tune the processing system for higher probability of event detection and declaration or for lower rate of false positives. Additional information of camera location and orientation optionally comes from a Global Positioning System with Inertial Measurement System units, or similar types of hardware. The Processor includes a sequence of modular subsystems. The illustrative embodiment includes a standard infrared camera with four standard external microphones for sensory input coupled into a standard personal computer with the Processor installed as embedded software.

### BRIEF DESCRIPTION OF THE DRAWINGS

FIG. 1 is an illustrative diagram of the overall Flash Detection System with Clutter Rejection including the Flash Detector and Clutter Rejection Processor.

FIG. 2 is an illustrative diagram of the Camera Corrections Subsystem.

FIG. 3 is an illustrative diagram of the Event Detection Subsystem

FIG. 4 is an illustrative diagram of the Spatial Event Accumulator Subsystem.

FIG. 5 is an illustrative diagram of the Spatio-Temporal Tracking Subsystem.

FIG. 6 is an illustrative diagram of the Feature Discriminator Subsystem with Sensor Fusion.

FIGS. 7a-d are respectively a) an photographic frame N−1 showing an event before a gun flash, b) a subsequent photographic frame N showing an event during a gun flash, c) a difference image, and d) a portion of the difference image showing the brightest pixel, 4-brightest “quad”, a pixel gap, and the entire “event.”

### DETAILED DESCRIPTION OF THE INVENTION

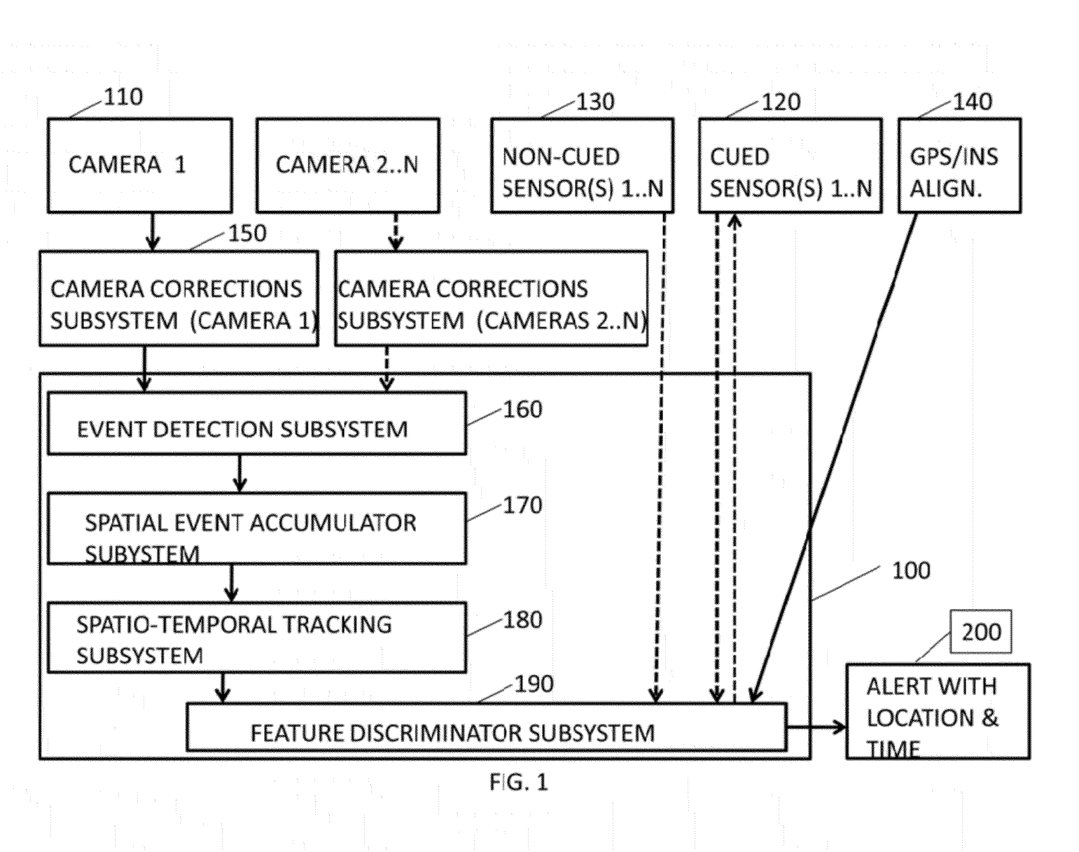

In an embodiment of the instant invention, the Flash Detector and Clutter Rejection Processor 100 takes input from one or multiple cameras and processes the camera video, together with user-supplied coefficients, position/alignment information, and information from other sensors to produce alerts with location and time information. The overall system covered by the Processor 100 is shown in FIG. 1 for an illustrative general configuration with multiple standard video cameras 110, standard cued sensors 120, standard non-cued sensors 130, and standard alignment sensors 140, such as Global Positioning System and Inertial Navigation Systems. Examples of standard video cameras 110 include Sony, Panasonic, JVC, Canon and other commercial cameras and DRS, Goodrich, Lockheed Martin, BAE-Systems, Radiance, and Northrop-Grumman branded standard military cameras. Examples of standard cued sensors 120 include standard acoustic microphone arrays, standard radars, standard millimeter wave systems, and standard ladars. Examples of standard non-cued sensors 130 include standard altimeters, standard radars, standard acoustic microphone arrays, standard millimeter wave systems, and standard ladars. The difference between the cued sensors and the non-cued sensors is that the processor 100 does not directly control the non-cued systems, but receives a stream of information to process.

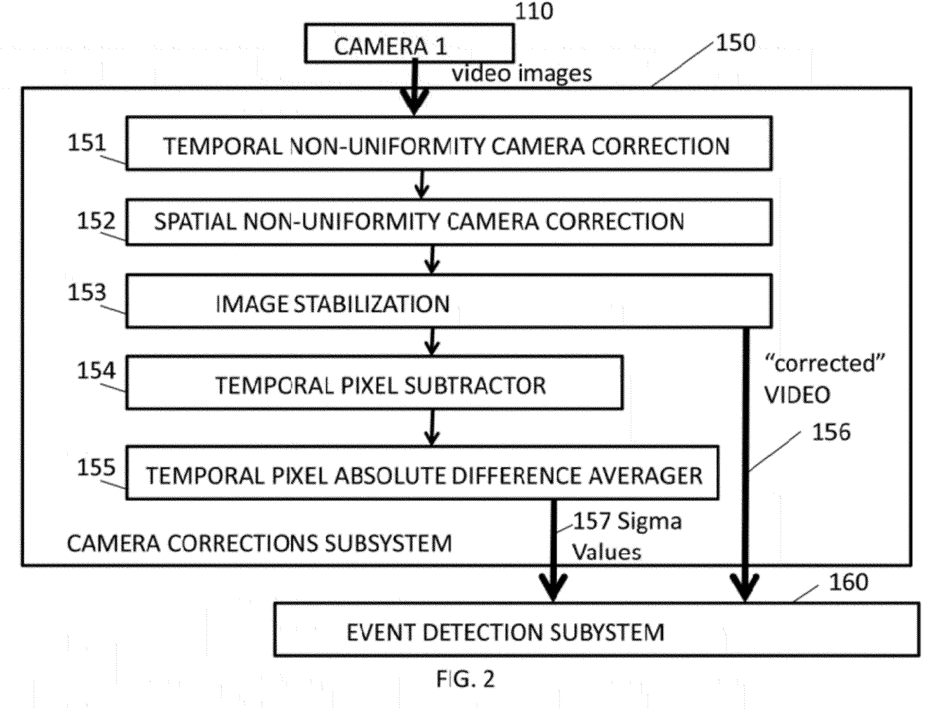

The Processor 100 communicates with one or more standard video cameras 110 via one or more Camera Corrections Subsystems 150. Camera Corrections Subsystem 150, a feature of any camera system used for flash detection, is described herein below with respect to FIG. 2.

In an illustrative embodiment of the invention, Processor 100 includes an event detection filter 160 receiving at least one camera video output, processing a time sequence of at least a current image and a previous image, generating a plurality of difference images from the time sequence, each difference image being based on a time-subtraction of the current image from the previous image, the time sequence above an ambient pixel intensity level including at least one of at least one true flash event and at least one false positive. Processor 100 further includes a spatial event accumulator 170 receiving the plurality of difference images from the event detection filter, merging a plurality of spatially proximate smaller flash events of the possible flash event to determine a shape of a single larger flash event, measuring pixel intensities of the plurality of spatially proximate smaller flash events to determine a varying brightness over the shape of the single larger flash event.

Optionally, the spatial event accumulator 170 sums temporarily processed pixel intensities of the single larger flash event, averaging the pixel intensities of the single larger flash event, identifying a brightest pixel of the single larger flash event, and identifying three brightest immediately neighboring pixels to form a brightest pixel quad. Optionally, Processor 100 includes a feature discriminator 190 that compares one of a ratio of a brightest pixel intensity to a spatial sum intensity to ratios of actual gunfire events and a ratio of a brightest pixel quad intensity to a spatial sum intensity to ratios of actual gunfire events, said feature discriminator thereby comparing a size and the shape of the single larger flash event to sizes and shapes of the actual gunfire events. Optionally, Processor 100 includes a spatio-temporal tracking filter 180 communicating with the spatial event accumulator 170 and the feature discriminator 190, the spatio-temporal tracking filter 180 tracking the single larger flash event as a function of time in global coordinates, the spatio-temporal tracking filter 180 identifying the single larger flash event as one of a flash event track and an isolated flash event; and a feature discriminator 190 rejecting the false positives and setting an event alert on identifying a true flash detection, said feature discriminator determining a neighbor pixel correlation or the single larger flash event, and determining the spatial density distribution within the larger flash event.

Optionally, the neighbor pixel correlation comprises neighboring pixels of the single larger flash event having corresponding changes in brightness as a function of time.

Optionally, the feature discriminator 190 distinguishes between regular event repetition and irregular event repetition in the plurality of difference images, the irregular event repetition being characterized as the false positive.

Optionally, the at least one flash event comprises a plurality of flash events, the feature discriminator 190 logically grouping together the plurality of flash events moving spatially across the plurality of difference images.

Optionally, the at least one flash event comprises a first plurality of flash events and at least one second flash event, wherein the feature discriminator 190 groups together the first plurality of flash events and the at least one second flash event, if the first plurality of flash events and the at least one second flash event share a common origination.

Optionally, Processor 100 further includes at least one sensor communicating with the event detection filter 160. Optionally, the at least one sensor comprises at least one of a standard video camera, a standard acoustic sensor, a standard electromagnetic field sensor, a standard millimeter wave detection sensor, a standard radar detection sensor, a standard active ladar/lidar sensor, a standard altimeter/inertial-orientation sensor, and a standard global positioning sensor with a standard ground topological database. Optionally, the feature discriminator 190 determines a pointing vector for the single larger flash event to determine the distance of the single larger flash event and matches the pointing vector to an audio recording from the acoustic sensor to determine a direction of the single larger flash event. Optionally, the at least one sensor (120 or 130) comprises a plurality of sensors, said feature discriminator determining a distance to the single larger flash event based on a combination of data from the plurality of sensors. Optionally, the feature discriminator 190 determines a distance to the single larger flash event using expected intensities of actual gunfire events and expected intensities of false positives. Optionally, the feature discriminator 190 determines a size and the shape of the single larger flash event using the expected intensities of the true events and the expected intensities of false positives.

Optionally, the event alert comprises one of an audio communication to a user, a visual communication to a user, a recording, and a communication to a standard countermeasure response system.

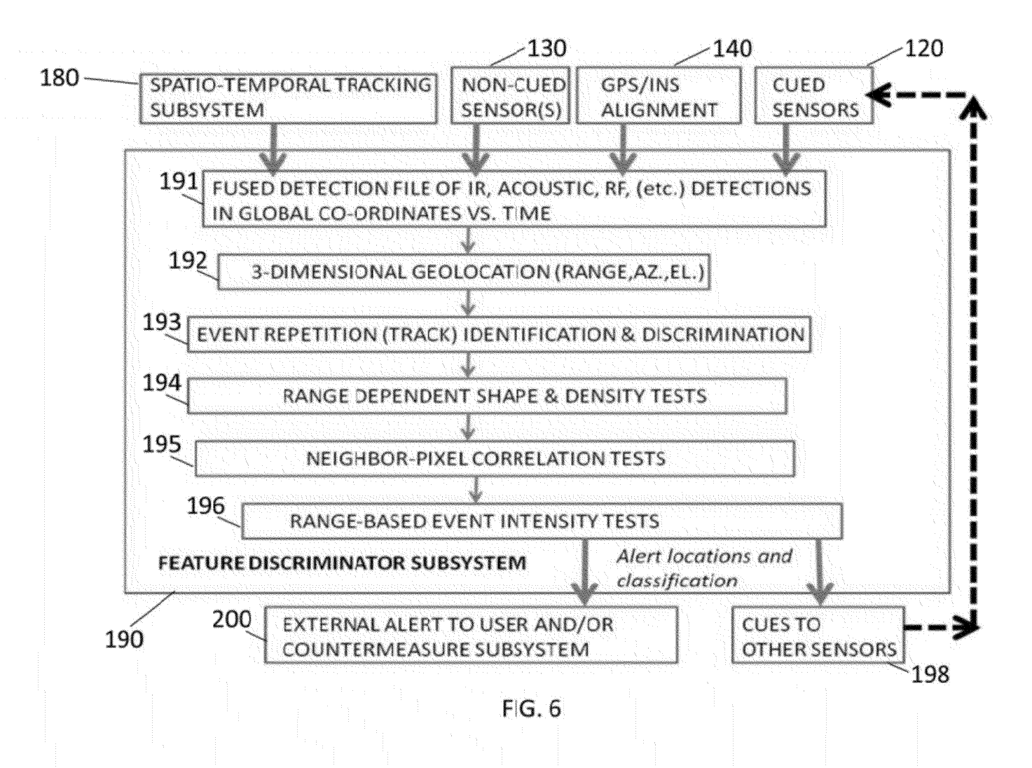

In another illustrative embodiment of the instant invention, the Processor 100 includes Event Detection Subsystem 160, Spatial Event Accumulator Subsystem 170, Spatio-temporal Tracking Subsystem 180, and/or Feature Discriminator Subsystem 190. The video of the one or more cameras 110 is processed by the Camera Corrections Subsystem 150, the Event Detection Subsystem 160, the Spatial Event Accumulator Subsystem 170, and the Spatio-Temporal Tracking Subsystem 180. The Spatio-Temporal Tracking Subsystem 180 sends processed “detected” events and tracks (i.e., “detected” event sequences) tagged with relevant information such as intensity-location history of the extracted event or extracted track into the Feature Discriminator Subsystem 190. The external sensors such as cued sensors (for example, an active radar system), non-cued sensors (for example, a passive acoustic system), and the GPS/INS/Alignment systems feed information into the Feature Discriminator Subsystem 190 of FIG. 6. It is this final subsystem which will output external alerts as well as internal cues to the cued sensors 120.

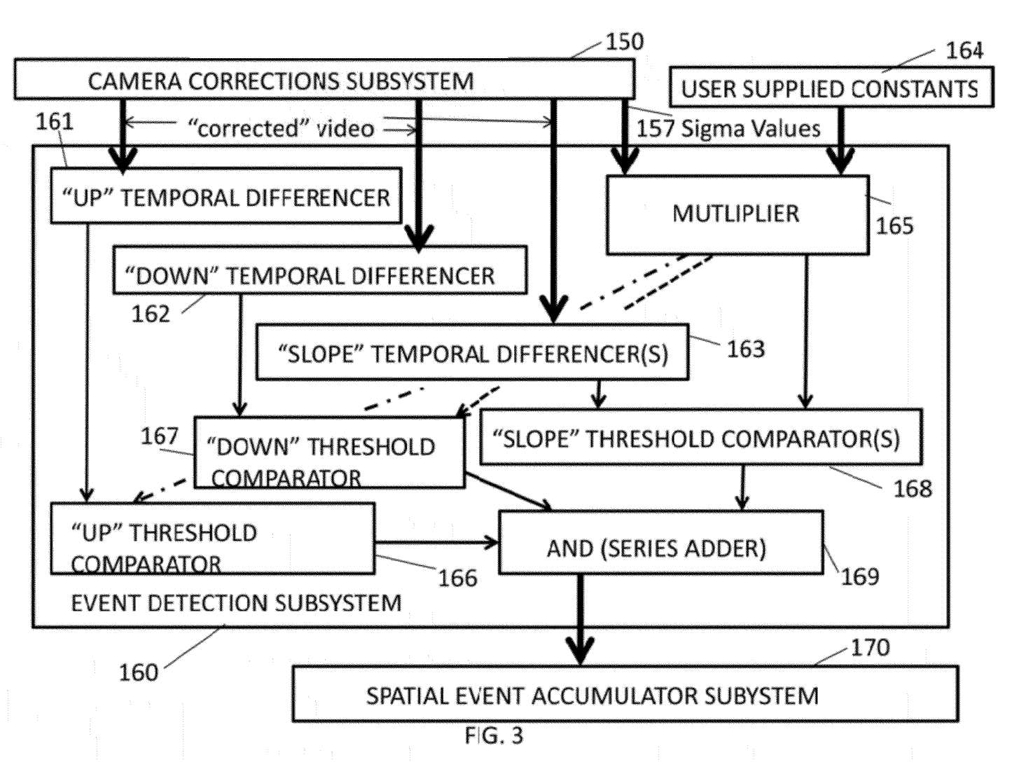

Event Detection Subsystem 160, Spatial Event Accumulator Subsystem 170, Spatio-temporal Tracking Subsystem 180, and/or Feature Discriminator Subsystem 190, which are shown in FIG. 1, are described herein below with respect to an illustrative embodiment of the instant invention at greater length and are shown in expanded modular form in FIGS. 3-6.

Camera Correction Subsystem

The Camera Corrections Subsystem 150 takes the raw camera video stream and corrects it for camera non-uniformities as well as provides the subsequent processing system with estimates of camera noise. The camera 110 (or each camera, if multiple cameras are used) comes with factory corrections which may be updated by user external calibrations. This subsystem is applicable after all other calibration has been completed. The temporal and spatial non-uniformity corrections are optional to the image processor and are not subject of any claims in this patent; however, it may be applied to obtain better looking video for the operator.

In the temporal non-uniformity camera correction 151, each camera video pixel i,j at frame N is compared with a running average (sometimes called the pixel offset) of the value of pixel i,j from frame N−1. in each video frame, the running average is updated by taking a small amount (example 0.001) of the frame N value and adding it to the complementary amount (example 0.999) of the frame N−1 running sum. This is done on a pixel by pixel basis for the video imagery. The corrected video takes the raw video at frame N, subtracts the running sum and then adds a user-supplied constant for grayscale adjustment for the user (e.g. so the displayed values are not negative. Any video used by an operator will be this corrected video. The raw video, however, will be used for the Event Detection Subsystem 160 of FIG. 3. Similarly, spatial corrections 152 by defocusing the camera and then averaging pixels spatially (which approximate the amount of defocus) to correct for non-uniformity distortions can be added to the user video. Other spatial and temporal variants may be used. The non-uniformity corrections are not necessary for the process to work.

Differences in the raw video signal of pixel i,j from frame N to its previous frame N−1 are obtained in the temporal pixel subtractor 154, which takes the value of each pixel in frame N and removes via subtraction the value of the identical pixel in the previous frame N−1. An absolute value of this difference is compared with a running sum from previous differences 155. Again, the running sum is updated similar to how raw video is corrected for viewing by subsequent operators. The running absolute difference at frame N−1 is multiplied by a number such as 0.999 and added to the running absolute difference of frame N times 0.001. The two coefficients add up to 1. This running difference for each pixel i,j is known as the sigma values and correspond to the mean temporal noise signal in each pixel of the camera 157. An alternative embodiment uses the root-mean-square method, instead of the absolute average value method, to obtain sigma values. The raw 110, corrected 156, and sigma 157 video sequences are passed to the Event Detection Subsystem depicted in FIG. 3.

Event Detection Subsystem

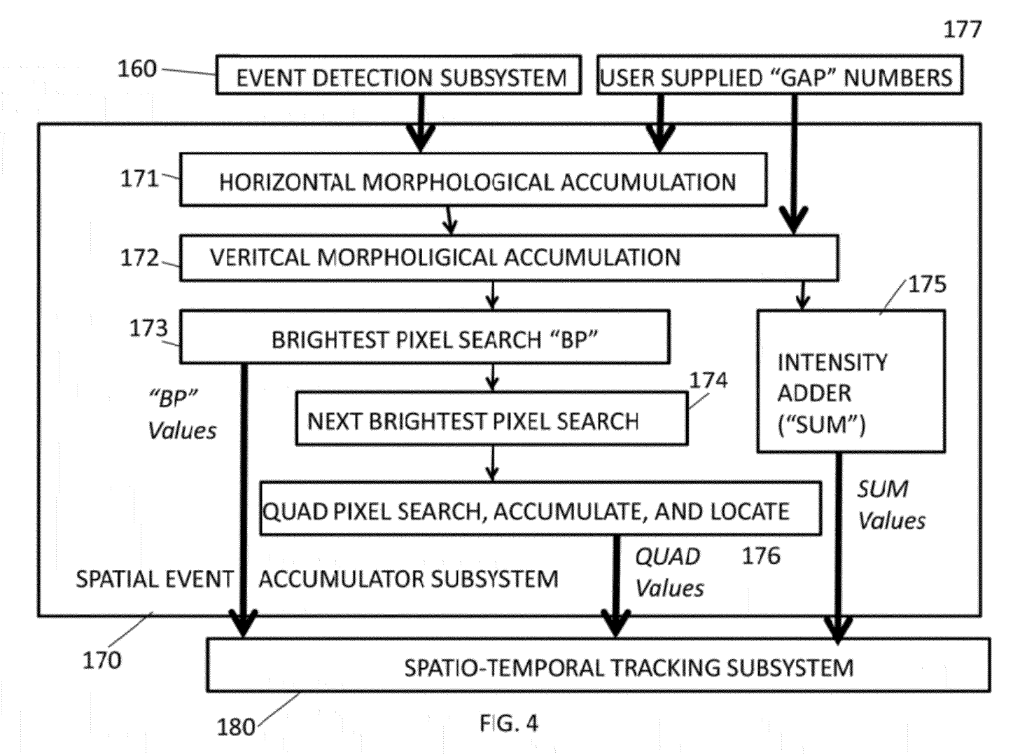

The Event Detection Subsystem is depicted in FIG. 3. It receives raw camera video imagery from the Camera Corrections Subsystem 150 (FIG. 2) and outputs information on “events” to the Spatial Event Accumulator Subsystem 170 of FIG. 4. Each “event” contains a small subset of the camera video which may correspond to a true flash detection or a false positive which resembles a flash detection. User-supplied constants 164, sometimes referred to as “thresholds,” are also used in the Event Detection Subsystem 160. These constants may be hard-wired at the factory or they may be supplied as external inputs by the user. In an alternative embodiment, the camera processor 100 alters the user-supplied constants based upon the rate of false positives in the video processing.

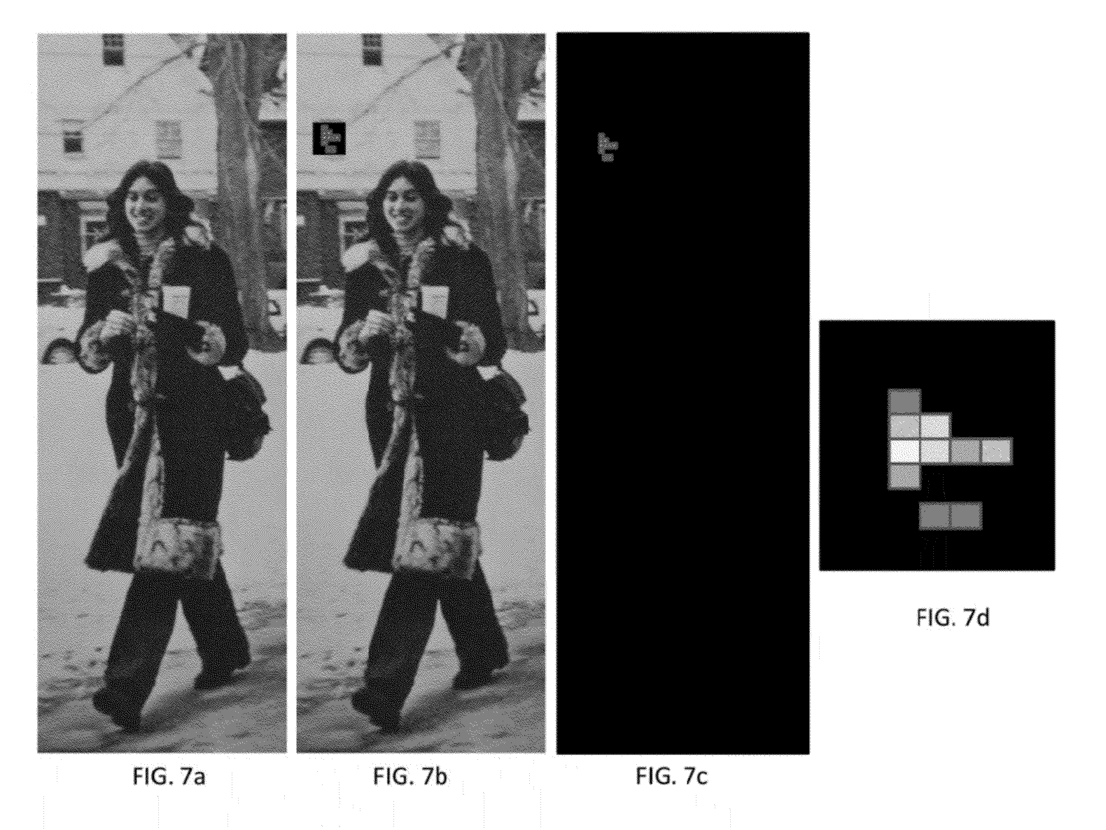

The Event Detection Subsystem 160 buffers a replaceable stack of sequential uncorrected video frames. To explain by using an example, FIGS. 7a-d are examined for a potential gun flash in a window. More particularly, in FIG. 7a, camera video frame N−1 is taken before a potential gun flash; in FIG. 7b, camera video frame N shows a potential gun flash in the window. When a new frame of camera data conies in, each frame is moved back in the buffer stack. The Up Temporal Differencer 161 takes all the digital values of frame N (such as shown in FIG. 7b) of corrected camera video and subtracts on a pixel-by-pixel basis the digital values of the previous frame, frame N−1 (such as shown in FIG. 7a). The result is a frame of “UP” difference video, such as shown in FIG. 7c. These difference images are sent to the Up Threshold Comparator 166. In this case, the UP Threshold Comparator 166 contrasts the value of the difference image with a threshold image consisting of a user-supplied multiplying constant 164 (e.g., 5) times the sigma value 157 for that pixel which is done by the multiplier 165. If the value of one of the pixels in the difference image exceeds the threshold image (e.g. the usersupplied constant times the average absolute difference or 5 times sigma), that pixel has “passed” the Up Threshold Comparator 166 and is sent on for further processing by the series adder 169.

Similarly, a Down Temporal Differencer 162 takes the frame N and subtracts a subsequent video frame when it is available. The Down Temporal Differencer is designed to look for a signal that decreases in time; hence, it subtracts from frame N a subsequent frame of video when camera video 156 from frame N+1 is available to the processor 100. In an illustrative embodiment, that was the frame N+2 (i.e., 2 frames later); but, it could be a different number than N+2 depending on the fall time of the expected short-duration flash signal. The result of a pixel-by-pixel digital subtraction is to get Down temporal difference video, which will be fed into the Down Threshold Comparator 167. The Down threshold comparator takes the Down temporal difference video and compares it with the output of the multiplier 165 of the user-supplied constant 164 with the sigma value 157 on a pixel-by-pixel basis. The user supplied constant for the Down Threshold comparator 167 does not have to be identical to the user supplied constant used in the Up Threshold Comparator 166.

Since the event peak is either in frame N or N+1, the nominal time tag of the event is frame N. A more precise measurement can be obtained by appropriately weighting the intensity of the accumulated signal in frames N and N+1 which can be done after the Spatial Event Accumulator Subsystem 170 of FIG. 4. For the description of the Event Detection subsystem, the time of the flash event can be approximated by frame N and its associated time. The UP and DOWN temporal differences on a pixel-by-pixel get sent to the UP and DOWN Threshold Comparators 166, 167, which compare the difference on a pixel-by-pixel basis with a user-supplied constant 164 multiplied by the sigma value 156 of that pixel (for frame N) 165. The user-supplied constants 164 typically range from 4 to 20 and can be pre-set, externally inputed by a user on a case-by-case basis, or can be iterated by additional signal processing within the processor 100. If the UP value of a pixel is greater than the user-supplied 164 times sigma of that pixel 156, the Up Threshold Comparator 166 will send out a PASS THRESHOLD indicator to a series adder 169. Similarly, the Down Threshold Comparator 167 will examine a user constant number multiplied by sigma on a pixel-by-pixel basis. The pixels where DOWN is greater than the constant times sigma will result in a PASS THRESHOLD indicator sent to Series Adder 169.

The Slope Temporal Differencers 163 use frames before and after the short duration flash associated with the time of frame N. Optionally, there are one or more Slope Temporal Differencers 163 and corresponding Slope Threshold Comparators 168. The Slope Temporal Differencer 163 takes a pixel-by-pixel difference of frame N+3 and frame N−2 in an illustrative embodiment of the invention. More than one slope temporal differences are recommended. The number of slope differences is limited by computational power and any expected repeat times of flash events. Hence, one can alternatively do a Slope Temporal Differencer 163 of the video of frames N+4 with N−2 or N+5 with N−3, for example.

The frame differencing operation of the Slope Temporal Differencer 163 is a pixel-by-pixel subtraction of two frames just like the Up Temporal and Down Temporal Differencers 161, 162, respectively, but with a different choice of image frames for the slope temporal difference(s). This will be determined to match two phenomena: the fall time of the signal and any expected repetition rate of the flash signal. The purpose of the Slope Temporal Differencer 163 is to see that the original signal before and after the flash event are nearly identical, at least in relation to the flash itself.

The Slope Threshold Comparator(s) 168 compare the slope difference(s) with a user supplied constant 164 (which may be the same of different from the constants used in the Up Threshold and Down Threshold Comparators 166, 167) and the UP Temporal Differencer 161 on a pixel-by-pixel basis. If the absolute value of the Slope Temporal Differencer 163 multiplied by the user-supplied constant is less than the UP difference value for that pixel, then a PASS THRESOLD signal is sent to the Series Adder 169. Hence, the Slope Temporal Differencer 163 rejects a “step-function” type of signal increase. For example, a signal that goes: 100-100-100-200-150-150-150 would have an UP (difference) value of 100 and a SLOPE value of 50. If the user-supplied constant K were for example 5, the SLOPE of 50 times 5 would be 250 and far greater than the UP difference value of 100. In that case, no “PASS THRESHOLD” signal would go to the Series Adder 169. Each Slope Differencer will also have its own Slope Threshold Comparator 168.

Finally, the Series Adder 169 checks the PASS THRESHOLD signals that correspond to each camera pixel i,j of frame N. This is likely to occur at a clock time several frames after the time of frame N because of the inherent delay of the Slope Temporal Differencer 163, which uses (for example) frame N+3. If pass threshold signals come from all the threshold comparators, namely, the Up, Down, and all the Slope threshold comparators 166, 167, 168, then an event is said to exist at time N and pixel location i,j. The value of the signals from the Up, Down, and Slope Temporal Differencers 161, 162, 163 as well as the sigma value and the space-time locations i,j, and N are passed on to the Spatial Event Accumulator Subsystem 170 depicted in FIG. 4. An additional value of the difference between frame N+1 and N+2 is also passed along with the information mentioned in the previous sentence for further accumulation. Depending on the duration of the flash signal fall time, the amount of passed-along information may be increased as appropriate to the signal shape. For cases when the frame rate of the digital video camera 110 is very high (i.e., that the time duration of each frame is small compared to the time duration of the flash event), a different type of filtering (e.g., a standard temporally matched filter) is used instead of the image processing techniques of the Event Detection Subsystem 160, which has been optimized for detection of temporally unresolved flash events. Regardless of the frame rate of the digital camera, candidate flash events are sent by an Event Detection Subsystem 160 into a Spatial Event Accumulator Subsystem 170.

Spatial Event Accumulator Subsystem

The Spatial Event Accumulator Subsystem 170 is depicted in FIG. 4. The overall purpose of this signal processing module is to take spatially adjacent or nearby flash events and merge them into a single, larger flash event. For example, if a flash event occurs in camera pixel locations 222,408 and 222,409 and 223,408 and 223,409—it will be merged into one event taking place over 4 pixels. For a given frame N, the Horizontal Morphological Accumulator 171 is a dataflow function that examines a given row of camera data. If it finds an event in row i at pixel ij, it then looks at the next pixel ij+1 for another event. Every time a new event is added to a given blob, the “blob search radius” expands to accommodate the new shape of the blob. A User-Supplied Gap Coefficient or Number 177 (e.g., set at the factory or externally supplied by user on a case-by-case basis) allows this accumulator to coast. An example of a user-supplied Gap Number 177 is the blob search radius. In other words, if the Horizontal Morphological Accumulator 171 finds events in pixel 222,408 and pixel 222,409 but not in pixel 222,410, it may still look at pixel 222, 411 for an event if the gap number is 1 or larger. An example of a gap in a flash detection event is shown in FIG. 7d. The Vertical Morphological Accumulator 172 works the same way as the Horizontal Morphological Accumulator with columns j, j+1, j+2 etc. As with the Horizontal Morphological Accumulator 171, the Vertical Morphological Accumulator 172 allows for gaps in the spatial event with a user-supplied gap coefficient or number. The output of the horizontal and vertical morphological accumulators is a single multi-pixel spatial event at time corresponding to frame N taking place over a large number of camera pixels.

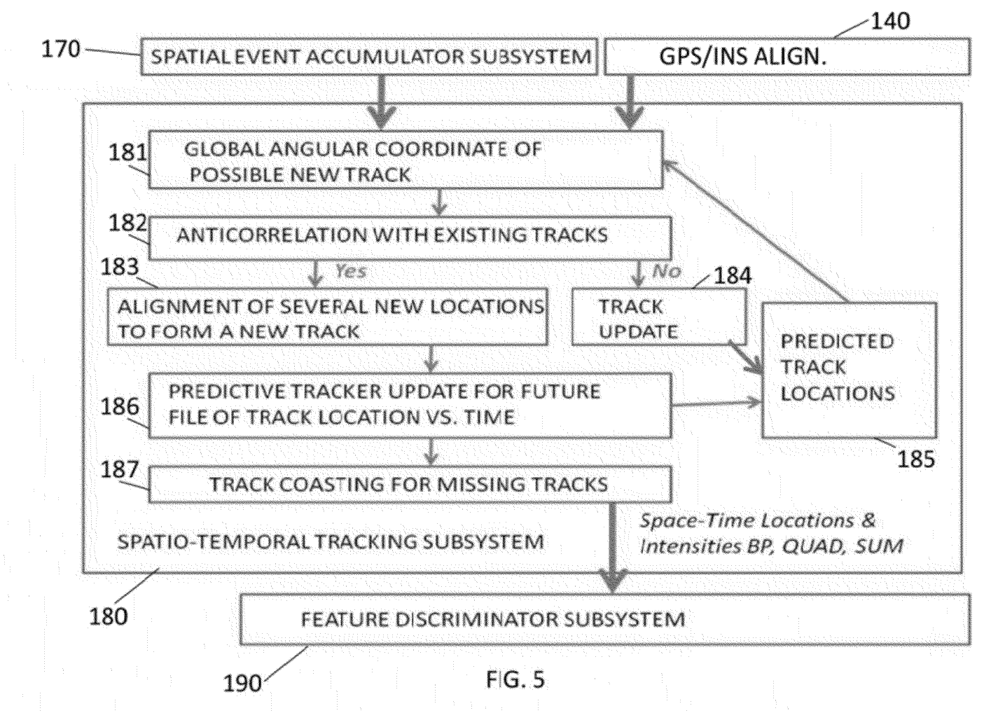

The value of each spatial pixel in the event is examined for the total flash signal. In the preferred embodiment, that is the value of pixel ij at frames N and N+1 subtracted by the values at frames N−1 and N+2. This specific implementation may be altered or a different flash event duration and a different camera frame time as appropriate by the phenomena of the expected signal. This signal for each pixel can be referred to as the total intensity of i,j. All the spatial pixels are compared for the brightest pixel, the pixel with the maximum intensity. The value of this intensity is referred to as the “BP” value for “Brightest Pixel” 173. The next brightest pixel that is adjacent horizontally or vertically helps to form a search for the brightest pixel after that in a perpendicular direction. This will define a QUAD of pixels of which the brightest pixel is one of the 4 pixels 176. The brightest pixel 173 and a 2×2 QUAD 176 are illustrated in FIG. 7d. The intensity weighted i,j location within the quad will be the event location. The intensity weighted time from frame differences [N−(N−1)] vs. [(N+1)−(N+2)] forms the time of the event. The sum of all intensities within the spatial accumulator forms the SUM value. In FIG. 7d, the SUM is the addition of all the “flash difference” values in the defined spatial region. The spatial and time locations of the event, as well as BP, QUAD, and SUM are then passed to the Spatio-Temporal Tracking Subsystem 180 of FIG. 5.

Spatio—Temporal Tracking Subsystem

The Spatio-temporal Tracking Subsystem 180 is depicted in FIG. 5. This module tracks the accumulated flash events from the output of the Spatial Event Accumulator Subsystem 170 of FIG. 4 as a function of time in global (up-down-north-east-south-west) coordinates instead of camera coordinates. Sensor platform location information from standard Global Positioning Systems as well as standard Inertial Navigational Systems 140 (or standard inertial measurement units) as well as any platform information (e.g., if the sensor is mounted a certain way on a moving vehicle—ground, air, or sea) is used to determine global coordinate angles from camera angle 181. These standard camera-to-global-coordinate techniques are not the subject of this invention. The camera alignment and orientation and the sensor platform location and alignment are used to transform the camera pixel information into a sensor platform reference system or into a global (e.g. earth latitude, longitude, and altitude) reference system by standard industry coordinate transformation methods, such as discussed at http://en.wikipedia.org/wiki/Frame_of_reference, incorporated herein by reference.

Spatio-temporal Tracking Subsystem 180 includes a standard predictive tracker 185, which looks for sequential temporal events. For example, the predictive tracker 185 includes an alpha-beta filter, Kalman filter, or other iterative track filter. Optionally, the predictive tracker 185 is used to back-track any spatial track for a few frames (per some user-supplied number) to see whether the event comes in from outside the field of regard of the camera.

Single frame events (e.g. isolated events with no time-track history) will output the Spatio-temporal Tracking Subsystem 180 unchanged from the output of the Spatial Event Accumulator Subsystem 170. They will be tagged as isolated events 183. Others will be identified as time dependent tracks with intensity information (BP, QUAD, and SUM) and location history as a function of time. A notation will also follow if the event appears to arise from outside the camera field of regard. The tracks and isolated events are all passed to the Feature Discriminator Subsystem 190 of FIG. 6.

Feature Discriminator Subsystem

The Feature Discriminator Subsystem 190 is depicted in FIG. 6. It operates in a stand-alone mode for an individual camera, or may involve sensor fusion of multiple cameras or other combinations of event detection sensors such as acoustic sensors, electromagnetic field sensors, millimeter wave detection sensors, radar detection sensors or active ladar/lidar. Thus, if the timing and location of an event from the infrared camera is physically consistent with the timing and location from an acoustic microphone array (e.g., the event will arise later in the acoustic microphone array due to the difference between the velocity of light and the velocity of sound), this information can be utilized for greater confidence that such an event is not a false positive. This sensor fusion is applicable to short duration electro-optical flash events that are correlated with other physical phenomena such as acoustical sound generation, electromagnetic field generation, and object motion. These sensors could be passive or active sensors and may or may not be cued by the Feature Discriminator Subsystem 190 based on the other sensors. This description hereinbelow will first describe the Feature Discriminator Subsystem 190 in a stand-alone mode and later mention alternatives for a sensor-fused mode.

In the stand-alone mode, tracks are checked for regularity, track quality, and intensity history 193. Tracks that repeat on a regular basis are noted as repeater tracks and can correspond to a regularly modulating flash event. Tracks that start out initially bright and then are followed by a rapidly updated lower intensity sequence are noted as ejected events. Irregular tracks not corresponding to any expected multiple-time events are noted as irregular tracks. These irregular tracks are generally not used for alarms since they are most likely to be false positives such as cars, birds, or other moving objects.

Density tests 194 consist of examining the ratios of BP/SUM and QUAD/SUM and comparing them with the expected signals from the desired flash events. The overall size and shape can be compared with the expected signal as well. In the sensor fusion mode, there may be a range indicator (from optical-infrared time delay and/or from shock-wave blast-event for acoustic by itself and/or from velocity from an active Doppler-based radar/millimeter-wave/ladar/lidar system). Any expected velocity of the event or range of the event may provide more information to modify the density and shape tests. The range can also be determined if the sensor is elevated, for example, using a combination of altimeter, orientation, and an elevation database. An event that is far away is likely to be denser and have smaller shape than an event that is close-in. Thus, an event with very large size far away might be rejected as it might correspond to a bright fire and not a flash event. These tests may not be able to reject events that are so bright as to saturate the camera.

Neighbor pixels within the spatially identified event (see, e.g., FIG. 7d) are examined that all pixels engage in coherent temporal behavior. In other words, all of the pixels of an accumulated event go up and down in time together. These form the neighbor-pixel correlation tests 195 and have been found to be a powerful feature to distinguish desired flash events from false positive events, such as those arising from solar glints and/or moving background sources. The test would only apply to those signals that are significantly brighter than the camera temporal noise (sigma) level. Some or all of the neighbor pixels in an event may be examined for coherency. The result of passing this test would be to send the event on to the external alert and cue to externally cued sensors. These tests may not be applicable in the case of a close-in flash that saturates the camera.

Finally, a range-based intensity test is optionally applied to the event 196. If the event is close by, the SUM should be a very bright number while if the event is far away, the SUM need not be a very bright number.

All of these Feature Discriminator tests can be applied to isolated events as well as to initial events of an ejector sequence track or individual events of a regularly repeated event sequence. Those that pass these tests can provide alert locations (i.e., azimuth, elevation, range, and time) and event classification (e.g., isolated, repeated, ejector-sequence, etc.) and intensity to an event alert as well as cues to other sensors. If on an elevated or airborne platform, this could be combined with other spatial location information and databases to identify event locations on the ground. The external alert can be given to a user (on-board or remotely located), a recorder, or a standard countermeasure response system. If only passive optical systems are used, it may be impossible to get an accurate range value. If multiple cameras are used, it may be advantageous to do spectral Feature Discriminating. Spectral discrimination using a plurality of cameras of different wavelength (or a single camera with multiple wavelength video) can be done by either comparing ratios of the SUM video signal in the chosen spectral bands or by a standard spectral subtraction technique, such as disclosed in U.S. Pat. No. 5,371,542, incorporated herein by reference.

The purpose of the Feature Discriminator Subsystem 190 is to reject most false positive events and false positive tracks. It is desirable that the Feature Discriminator Subsystem 190 output mostly true flash events of interest. It is also desirable that the entire Flash Detection and Clutter Rejection Processor 100 successfully find space-time locations of flash events with a high probability of detection and a minimal number or false positives. The output of the Feature Discriminator Subsystem 190 is sent as cues to other sensors 198 or sent as alerts to the user or a standard countermeasure system 200.

An embodiment of the invention comprises a computer program that embodies the functions, filters, or subsystems described herein and illustrated in the appended subsystem diagrams. However, it should be apparent that there could be many different ways of implementing the invention in computer programming, and the invention should not be construed as limited to any one set of computer program instructions. Further, a skilled programmer would be able to write such a computer program to implement an exemplary embodiment based on the appended diagrams and associated description in the application text. Therefore, disclosure of a particular set of program code instructions is not considered necessary for an adequate understanding of how to make and use the invention. The inventive functionality of the claimed computer program will be explained in more detail in the following description read in conjunction with the figures illustrating the program flow.

One of ordinary skill in the art will recognize that the methods, systems, and control laws discussed above may be implemented in software as software modules or instructions, in hardware (e.g., a standard field-programmable gate array (“FPGA”) or a standard application-specific integrated circuit (“ASIC”), or in a combination of software and hardware. The methods, systems, and control laws described herein may be implemented on many different types of processing devices by program code comprising program instructions that are executable by one or more processors. The software program instructions may include source code, object code, machine code, or any other stored data that is operable to cause a processing system to perform methods described herein.

The methods, systems, and control laws may be provided on many different types of computer-readable media including computer storage mechanisms (e.g., CD-ROM, diskette, RAM, flash memory, computer's hard drive, etc.) that contain instructions for use in execution by a processor to perform the methods' operations and implement the systems described herein.

The computer components, software modules, functions and/or data structures described herein may be connected directly or indirectly to each other in order to allow the flow of data needed for their operations. It is also noted that software instructions or a module can be implemented for example as a subroutine unit or code, or as a software function unit of code, or as an object (as in an object-oriented paradigm), or as an applet, or in a computer script language, or as another type of computer code or firmware. The software components and/or functionality may be located on a single device or distributed across multiple devices depending upon the situation at hand.

Systems and methods disclosed herein may use data signals conveyed using networks (e.g., local area network, wide area network, internet, etc.), fiber optic medium, carrier waves, wireless networks, etc. for communication with one or more data processing devices. The data signals can carry any or all of the data disclosed herein that is provided to or from a device.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

These and other implementations are within the scope of the following claims.

What is claimed as new and desired to be protected by Letters Patent of the United States is:

1. An apparatus comprising:
an event detection filter receiving at least one camera video output, processing a time sequence of at least a current image and a previous image, generating a plurality of difference images from the time sequence, each difference image being based on a time-subtraction of the current image from the previous image, the time sequence above an ambient pixel intensity level including at least one of at least one true flash event and at least one false positive; and
a spatial event accumulator receiving the plurality of difference images from the event detection filter, merging a plurality of spatially proximate smaller flash events of the possible flash event to determine a shape of a single larger flash event, measuring pixel intensities of the plurality of spatially proximate smaller flash events to determine a varying brightness over the shape of the single larger flash event.

2. The apparatus according to claim 1, wherein said spatial event accumulator sums temporarily processed pixel intensities of the single larger flash event, averaging the pixel intensities of the single larger flash event, identifying a brightest pixel of the single larger flash event, and identifying three brightest immediately neighboring pixels to form a brightest pixel quad,
wherein said apparatus further comprises a feature discriminator rejecting the at least one false positive and setting an event alert on identifying a true flash detection, said feature discriminator determining a neighbor pixel correlation of the single larger flash event, and determining the spatial density distribution within the larger flash event.

3. The apparatus according to claim 2, wherein said feature discriminator compares one of a ratio of a brightest pixel intensity to a spatial sum intensity to ratios of actual gunfire events and a ratio of a brightest pixel quad intensity to a spatial sum intensity to ratios of actual gunfire events, said feature discriminator thereby comparing a size and the shape of the single larger flash event to sizes and shapes of the actual gunfire events.

4. The apparatus according to claim 2, further comprising:
a spatio-temporal tracking filter communicating with said spatial event accumulator and said feature discriminator, said spatio-temporal tracking filter tracking the single larger flash event as a function of time in global coordinates, said spatio-temporal tracking filter identifying the single larger flash event as one of a flash event track and an isolated flash event.

5. The apparatus according to claim 2, wherein the neighbor pixel correlation comprises neighboring pixels of the single larger flash event having corresponding changes in brightness as a function of time.

6. The apparatus according to claim 2, wherein said feature discriminator distinguishes between regular event repetition and irregular event repetition in the plurality of difference images, the irregular event repetition being characterized as the false positive.

7. The apparatus according to claim 2, wherein said at least one flash event comprises a plurality of flash events, said feature discriminator logically grouping together the plurality of flash events moving spatially across the plurality of difference images.

8. The apparatus according to claim 2, wherein said at least one flash event comprises a first plurality of flash events and at least one second flash event, wherein said feature discriminator groups together the first plurality of flash events and the at least one second flash event, if the first plurality of flash events and the at least one second flash event share a common origination.

9. The apparatus according to claim 2, further comprising at least one sensor communicating with said event detection filter.

10. The apparatus according to claim 9, wherein said at least one sensor comprises at least one of a video camera, an acoustic sensor, an electromagnetic field sensor, a millimeter wave detection sensor, a radar detection sensor, an active ladar/lidar sensor, an altimeter/inertial-orientation sensor, and a global positioning sensor with a ground topological database.

11. The apparatus according to claim 10, wherein said feature discriminator determines a pointing vector for the single larger flash event to determine the distance of the single larger flash event and matches the pointing vector to an audio recording from the acoustic sensor to determine a direction of the single larger flash event.

12. The apparatus according to claim 10, wherein said at least one sensor comprises a plurality of sensors, said feature discriminator determining a distance to the single larger flash event based on a combination of data from the plurality of sensors.

13. The apparatus according to claim 12, wherein said feature discriminator determines a distance to the single larger flash event using expected intensities of actual gunfire events and expected intensities of false positives.

14. The apparatus according to claim 12, wherein said feature discriminator determines a size and the shape of the single larger flash event using the expected intensities of the true events and the expected intensities of false positives.

15. The apparatus according to claim 2, wherein the event alert comprises one of an audio communication to a user, a visual communication to a user, a recording, and a communication to a countermeasure response system.

16. The apparatus according to claim 1, wherein the event detection filter comprises at least one of an up comparator, a down comparator, and a slope comparator.

17. The apparatus according to claim 1, wherein the event detection filter comprises a series adder receiving one of output from an up threshold comparator and a down threshold comparator; output from the up threshold comparator and a slope threshold comparator; output from the up threshold comparator, the down threshold comparator, and the slope threshold comparator; output from a plurality of slope threshold comparators; and output from the up threshold comparator, the down threshold comparator, and the plurality of slope threshold comparators.
